(19) United States
(12) Patent Application Publication
(10) Pub. No.: US 2006/0126471 A1
(43) Pub. Date: Jun. 15, 2006

(54) Information recording apparatus, information recording method, information playback apparatus, information playback method, and information recording/playback apparatus

(75) Inventors: Teruyuki Tomonari, Kyoto (JP); Koichi Otsuka, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/301,024

(22) Filed: Dec. 13, 2005

(30) Foreign Application Priority Data
Dec. 14, 2004 (JP) 2004-360958
Oct. 19, 2005 (JP) 2005-304817

(51) Int. Cl. G11B 5/09

(52) U.S. Cl. 369/53.2; 369/47.1

(57) ABSTRACT

A content-list management unit classifies contents according to which optical disks the respective contents were input from, adds content selection information (i.e., information presented to select a content to be played back for playback) on the content to content lists associated with respective categories of the contents, and records the content lists on a recording medium.

### CROSS-REFERENCE TO RELATED APPLICATION

This Nonprovisional application claims priority under 35 U.S.C. §119(a) on Patent Application No. 2004-360958 filed in Japan on Dec. 14, 2004, the entire contents of which are hereby incorporated by reference. The entire contents of Patent Application No. 2005-304817 filed in Japan on Oct. 19, 2005 are also incorporated by reference.

### BACKGROUND OF THE INVENTION

(1) Field of the Invention

The present invention relates to information recording apparatus and methods for recording contents including input sounds and images on recording media such as memory cards and MiniDisks, information playback apparatus and methods for playing back contents recorded on the recording media, and information recording/playback apparatus.

(2) Description of the Related Art

In duplicating contents (such as video data and audio data) recorded on recording media, such as optical disks, on other recording media, such as MiniDisks and hard disks, a content list (playback list) containing information (content selection information) on contents such as titles of the contents or performers (singers) to be presented to select a content to be played back in playing back of contents and also containing information such as addresses at which the contents are recorded is recorded on the recording media such as MiniDisks and hard disks.

For example, during playback of contents by a player, titles included in a content list are displayed (presented) on, for example, a display section of the player and, if a user selects a content to be played back from, for example, the displayed titles and commands the player to play back the selected content, an associated content recorded on, for example, a hard disk is played back based on the address described above (see, for example, Japanese Unexamined Patent Publication No. 2002-343066).

FIG. 9 is a block diagram illustrating a configuration of an information recording apparatus 500 for recording a content list together with contents on a recording medium such as a hard disk. As shown in FIG. 9, the information recording apparatus 500 includes: a signal reader 501; a decoder 502; a write section 503; a microprocessor (CPU) 504; and a record control section 505.

The signal reader 501 reads data such as video data and audio data recorded on an optical disk 510.

The decoder 502 decodes and outputs the data such as video data and audio data read by the signal reader 501.

The write section 503 records the data decoded by the decoder 502 and a content list as described above on a recording medium 506. In the information recording apparatus 500, one content list is recorded on one recording medium 506.

The CPU 504 includes: a disk playback unit 504a; and a write control unit 504b. The disk playback unit 504a controls playback operation of the signal reader 501 and decoding operation of the decoder 502. The write control unit 504b controls data write operation of the write section 503.

The record control section 505 controls the CPU 504 according to a command from a user. Specifically, the record control section 505 includes: a key switch 505a with which the user enters a command to start copying, for example; and a sub-microcomputer 505b for outputting information according to the command from the user to the CPU 504.

The optical disk 510 is a recording medium on which a plurality of contents such as video data and audio data are recorded.

The recording medium 506 is a recording medium (e.g., a hard disk) on which video data and audio data are to be recorded.

It will be described how the information recording apparatus 500 having the foregoing configuration operates with reference to a flowchart shown in FIG. 10.

When a user operates the key switch 505a to specify a content to be recorded on the recording medium 506, for example, the following operation is performed.

The record control section 505 outputs, to the CPU 504, an instruction to play back the optical disk 510 (see process A in FIG. 10). Accordingly, the disk playback unit 504a of the CPU 504 controls the signal reader 501 so that the signal reader 501 reads a content recorded on the optical disk 510. The disk playback unit 504a also controls the decoder 502 so that the decoder 502 decodes the content read by the signal reader 501. The write section 503 is controlled by the write control unit 504b to record the content on the recording medium 506 and to add content selection information on this content to a content list on the recording medium 506 (see process C in FIG. 10).

If a user enters a command to read a plurality of contents from the optical disk 510, the foregoing operation is repeated until all the specified contents are recorded on the recording medium 506.

If a plurality of optical disks 510 are provided to read contents therefrom and a command to record these contents is entered, process C described above is repeatedly performed on the other optical disks 510 (see process D in FIG. 10).

In this manner, together with the recording of contents from the optical disks 510 on the recording medium 506, the content selection information is added to a content list on the recording medium 506.

To play back a contents recorded on the recording medium 506, titles included in a content list are displayed on, for example, a display section of a player and, if a user selects a content to be played back from, for example, the displayed titles, the selected content is read out and played back.

However, in recent years, the capacity of a recording medium 506 has increased and the information amount of contents recorded on one optical disk 510 has also increased. Accordingly, if information such as titles is included in only one content list, the amount of information included in the content list increases so that a large number of titles are presented in selecting a content to be played back. In addition, contents which were previously recorded and contents which are newly recorded are mixed in a record, so that an intended content cannot be identified until this content is actually played back for confirmation. Accordingly, as described above, if the conventional content list is used, it takes time to find a content intended by a user, so that it has become more and more difficult to easily select a content.

### SUMMARY OF THE INVENTION

It is therefore an object of the present invention to provide information recording apparatus and methods for recording, on a recording medium, a content list allowing a user to easily select an intended content from a large number of contents recorded on recording media such as MiniDisks.

In order to achieve this object, according to the present invention, an information recording apparatus for recording contents on a recording medium includes: content recording means for recording contents on the recording medium; and content-list recording means for adding content selection information items to content lists associated with respective categories of the contents and recording the content lists on the recording medium, the content selection information items being presented for selection in playing back the contents.

With this configuration, content lists associated with respective categories of contents are recorded on the recording medium, so that the amount of information included in each of the content lists is reduced. Accordingly, the time necessary for finding an intended content is reduced, and a content is selected easily.

In an aspect of the present invention, the apparatus further includes content reading means for reading a content recorded on a source recording medium, wherein the content-list recording means adds a content selection information item of the content to a content list associated with the source recording medium from which the content was read, and records the content list on the recording medium.

With this configuration, a content list including content selection information for each source recording medium such as an optical disk is recorded on the recording medium, so that the amount of information included in each of the content lists is reduced. Accordingly, the time necessary for finding an intended content is reduced, and a content is selected easily.

In another aspect of the present invention, the content-list recording means adds the content selection information items to the content lists associated with the respective categories of the contents according to tag information items added to input contents and serving as character information indicating attributes of the contents, and records the content lists on the recording medium.

In still another aspect of the present invention, the content-list recording means adds the content selection information items to the content lists associated with the respective categories of the contents according to one of, or a combination of some of, the tag information items, and records the content lists on the recording medium.

With this configuration, content selection information is classified according to tag information, so that the amount of information included in each of the content lists is reduced. Accordingly, the time necessary for finding an intended content is reduced, and a content is selected easily.

In yet another aspect of the present invention, the content recording means records, on the recording medium, one or more of input contents which belong to one of the categories associated with a specified one of the content lists.

With this configuration, only contents that match tag information specified by, for example, a user are recorded on the recording medium.

In another aspect of the present invention, in a case in which a content list associated with one of the categories to which a content to be recorded on the recording medium belongs has already been recorded on the recording medium, the content-list recording means adds a content selection information item of the content to be recorded on the recording medium to the already-recorded content list, and in the other case, the content-list recording means adds the content selection information item to a new content list and records the new content list on the recording medium.

With this configuration, if a content list associated with a category to which a content to be recorded belongs has not been recorded on the recording medium yet, a new content list is recorded on the recording medium. On the other hand, if such a content list has already been recorded, additional content search information is written in this content list recorded on the recording medium.

In another aspect of the present invention, the apparatus further includes genre estimating means for analyzing each of input contents and estimating a genre of the content, wherein the content-list recording means adds the content selection information items to the content lists according to the estimated genre, and records the content lists on the recording medium.

With this configuration, even in the case of recording a content having no tag information, the content selection information is classified according to the genre, so that the amount of information included in each of the content lists is reduced. Accordingly, the time necessary for finding an intended content is reduced, and a content is selected easily.

In another aspect of the present invention, each of the content lists is provided with identification information associated with a user, and in recording the contents on the recording medium, the content-list recording means adds the content selection information items to an associated one of the content lists in a case in which identification information input from outside the apparatus matches the identification information provided to the content list, and the content-list recording means adds the content selection information items to a new content list in the other case.

With this configuration, even in a case in which a plurality of users share a recording medium on which contents are to be recorded, only content lists associated with the user are presented in playback or editing of contents by, for example, a player. Accordingly, a content is selected more easily.

In another aspect of the present invention, the apparatus further includes: character information inputting means for inputting character information from outside the apparatus; and information changing means for changing the content selection information items included in the content lists as character information, tag information items of input contents and tag information items of contents recorded on the recording medium into character information input from the character information inputting means.

With this configuration, information included in, for example, content lists can be changed by a user.

In another aspect of the present invention, a method for recording contents on a recording medium includes: a content recording step of recording a content on the recording medium; and a content-list recording step of adding a content selection information item of the content to a content list associated with a category to which the content belongs, and recording the content list on the recording medium, the content selection information item being presented for selection in playing back the content.

With this method, content lists associated with categories of contents are recorded on the recording medium, so that the amount of information included in each of the content lists is reduced. Accordingly, the time necessary for finding an intended content is reduced, and a content is selected easily.

In another aspect of the present invention, an information playback apparatus for playing back a plurality of contents recorded on a recording medium includes: selection-information retrieving means for retrieving a content selection information item which matches or is similar to one or more content selection information items specified by a user from content selection information items included in a plurality of content lists associated with respective categories of the contents, each of the content lists including content selection information items presented for selection of one or more contents belonging to an associated one of the categories; and content playback means for playing back a content associated with the content selection information item retrieved by the selection-information retrieving means, wherein according to a specification by a user, the selection-information retrieving means selects one of the content lists through which a search is made and sets a search range with respect to content selection information items in the selected content list.

With this configuration, a content list is retrieved according to specification of a user, so that a content intended by the user is easily played back.

In another aspect of the present invention, after a search through one of the content lists, the selection-information retrieving means makes a search through another selected content list, and these searches are successively performed.

With this configuration, a plurality of content lists intended by a user is retrieved. Accordingly, even after a playback of a content list, another content list intended by a user can be successively played back.

In another aspect of the present invention, the apparatus further includes search-priority-level specifying means for specifying priority levels of the content lists through which a search is to be made, with respect to the selection-information retrieving means.

With this configuration, the priority levels of the content lists are specified in a search. Accordingly, even in a case in which a plurality of matching content selection information items are found in a search, the most appropriate content list information for a user can be selected.

In another aspect of the present invention, the apparatus further includes: information-search-range specifying means for specifying one of the content lists through which a search is to be made, with respect to the selection-information retrieving means; and search-list-range specifying means for specifying a search range for the content selection information items in the content list through which a search is to be made, with respect to the selection-information retrieving means.

With this configuration, a content list through which a search is to be made is allowed to be specified. Accordingly, it is possible to retrieve content selection information only from content lists intended by a user, even in a case in which a large number of content lists are provided.

In another aspect of the present invention, a method for playing back a plurality of contents recorded on a recording medium includes: a selection-information retrieving step of retrieving a content selection information item which matches or is similar to one or more content selection information items specified by a user from content selection information items included in a plurality of content lists associated with respective categories of the contents, each of the content lists including content selection information items presented for selection of one or more contents belonging to an associated one of the categories; and a content playback step of playing back a content associated with the retrieved content selection information item in a case in which a matching or similar content selection information item is retrieved at the selection-information retrieving step, while performing a playback using another content selection information item included in the content lists associated with one of the contents which is being played back at present or was played back in the past in a case in which neither a matching nor similar information item is retrieved at the selection-information retrieving step.

With this method, even in a case in which content selection information intended by a user is not included in a content list through which a search is to be made, it is possible to retrieve content selection information out of the search range, so that a search for a content intended by a user is made through all the content lists.

In another aspect of the present invention, the apparatus further includes playback-number acquiring means for acquiring number information indicating the number of instances in which each of the content lists was used for playback, wherein the selection-information retrieving means retrieves a content selection information item from one of the content lists selected according to the number information acquired by the playback-number acquiring means.

With this configuration, the number of instances in which a content list was used for playback is acquired, so that it is possible to play back contents using content lists in descending or ascending order of frequency in previous use by a user, or to play back contents according to the number of instances in which each content list was used in such a manner that the number of instances is the same for all the content lists.

In another aspect of the present invention, the apparatus further includes total-number acquiring means for acquiring information indicating a total number of instances in which each of the content lists was used for playback at a given time, wherein the selection-information retrieving means retrieves a content selection information item from one of the content lists selected according to the information indicating the total number acquired by the total-number acquiring means.

With this configuration, the number of instances in which a content list was used at a given time is acquired. Accordingly, a content list which has been frequently used by a user for playback at the current time is selected for playback. That is, it is possible to automatically play back contents using a specific content list, in place of an alarm clock, in the morning, for example.

In another aspect of the present invention, the apparatus further includes setting-information acquiring means for acquiring audio-setting information indicating an audio setting in a sound output effect in a playback of one of the contents, wherein the content playback means plays back the content with an audio output setting according to the audio-setting information acquired by the setting-information acquiring means.

With this configuration, audio-setting information is acquired for each content list, so that audio settings suitable for a content to be currently played back can be automatically selected.

In another aspect of the present invention, an information recording/playback apparatus for recording contents on a recording medium and playing back contents from the recording medium includes: content recording means for recording contents on the recording medium; content-list recording means for adding content selection information items to content lists associated with respective categories of the contents, and recording the content lists on the recording medium, the content selection information items being presented for selection in playing back the contents; selection-information retrieving means for retrieving one of the content selection information items which matches or is similar to one or more content selection information items specified by a user: content playback means for playing back one of the contents associated with the content selection information item retrieved by the selection-information retrieving means; and playback-number acquiring means for acquiring number information indicating the number of instances in which each of the content lists was used for playback, wherein the selection-information retrieving means retrieves the content selection information item from one of the content lists selected according to the number information acquired by the playback-number acquiring means.

With this configuration, the number of instances in which a content list was used is acquired, so that it is possible to play back contents using content lists in descending or ascending order of frequency in previous use by a user, or to play back contents according to the number of instances in which each content list was used in such a manner that the number of instances is the same for all the content lists.

In another aspect of the present invention, an information recording/playback apparatus for recording contents on a recording medium and playing back contents from the recording medium includes: content recording means for recording contents on the recording medium; content-list recording means for adding content selection information items to content lists associated with respective categories of the contents, and recording the content lists on the recording medium, the content selection information items being presented for selection in playing back the contents; selection-information retrieving means for retrieving one of the content selection information items which matches or is similar to one or more content selection information items specified by a user: content playback means for playing back one of the contents associated with the content selection information item retrieved by the selection-information retrieving means; and total-number acquiring means for acquiring information indicating a total number of instances in which each of the content lists was used for playback at a given time, wherein the selection-information retrieving means retrieves the content selection information item from one of the content lists selected according to the information indicating the total number acquired by the total-number acquiring means.

With this configuration, the number of instances in which a content list was used at a given time is acquired, so that a content list which has been frequently used at the current time by a user for playback is selected for playback. Accordingly, the apparatus is allowed to automatically play back a specific content, in place of an alarm clock, in the morning, for example.

In another aspect of the present invention, an information recording/playback apparatus for recording contents on a recording medium and playing back contents from the recording medium includes: content recording means for recording contents on the recording medium; content-list recording means for adding content selection information items to content lists associated with respective categories of the contents, and recording the content lists on the recording medium, the content selection information being presented for selection in playing back the contents; selection-information retrieving means for retrieving one of the content selection information items which matches or is similar to one or more content selection information items specified by a user: content playback means for playing back one of the contents associated with the content selection information item retrieved by the selection-information retrieving means; and setting-information acquiring means for acquiring audio-setting information indicating an audio setting in a sound output effect in a playback of one of the contents, wherein the content playback means plays back one of the contents with an audio output setting according to the audio-setting information acquired by the setting-information acquiring means.

With this configuration, audio-setting information is acquired for each content list, so that audio settings suitable for a content to be currently played back can be automatically selected.

In another aspect of the present invention, the apparatus further includes content-selection-information storing means for storing the content selection information items.

With this configuration, content selection information is held in a memory incorporated in the apparatus. Accordingly, even in a case in which contents are not intended to be recorded on the recording medium, the time necessary for finding an intended content is reduced, so that a content is easily selected.

In another aspect of the present invention, the apparatus further includes content-selection-information storing means for storing the content selection information items.

With this configuration, content selection information is held in a memory incorporated in the apparatus. Accordingly, even in a case in which contents cannot be recorded on the recording medium because the apparatus is used for playback only or a case in which contents are not intended to be recorded on the recording medium, it is possible to play back a content intended by a user.

In another aspect of the present invention, the apparatus further includes content-selection-information storing means for storing the content selection information items.

With this configuration, content selection information is held in a memory incorporated in the apparatus. Accordingly, even in a case in which contents are not intended to be recorded on the recording medium, it is possible to play back a content intended by a user.

### BRIEF DESCRIPTION OF THE DRAWINGS

FIG. 1 is a block diagram illustrating a configuration of an information recording apparatus according to a first embodiment of the present invention.

FIG. 2 is a flowchart showing operation of the information recording apparatus of the first embodiment.

FIG. 3 is a block diagram illustrating a configuration of an information recording apparatus according to a second embodiment of the present invention.

FIG. 4 is a flowchart showing operation of the information recording apparatus of the second embodiment.

FIG. 5 is a block diagram illustrating a configuration of an information recording apparatus according to a third embodiment of the present invention.

FIG. 6 is a flowchart showing operation of the information recording apparatus of the third embodiment.

FIG. 7 is a block diagram illustrating a configuration of an information recording apparatus according to a fourth embodiment of the present invention.

FIG. 8 is a flowchart showing operation of the information recording apparatus of the fourth embodiment.

FIG. 9 is a block diagram illustrating a configuration of a conventional information recording apparatus.

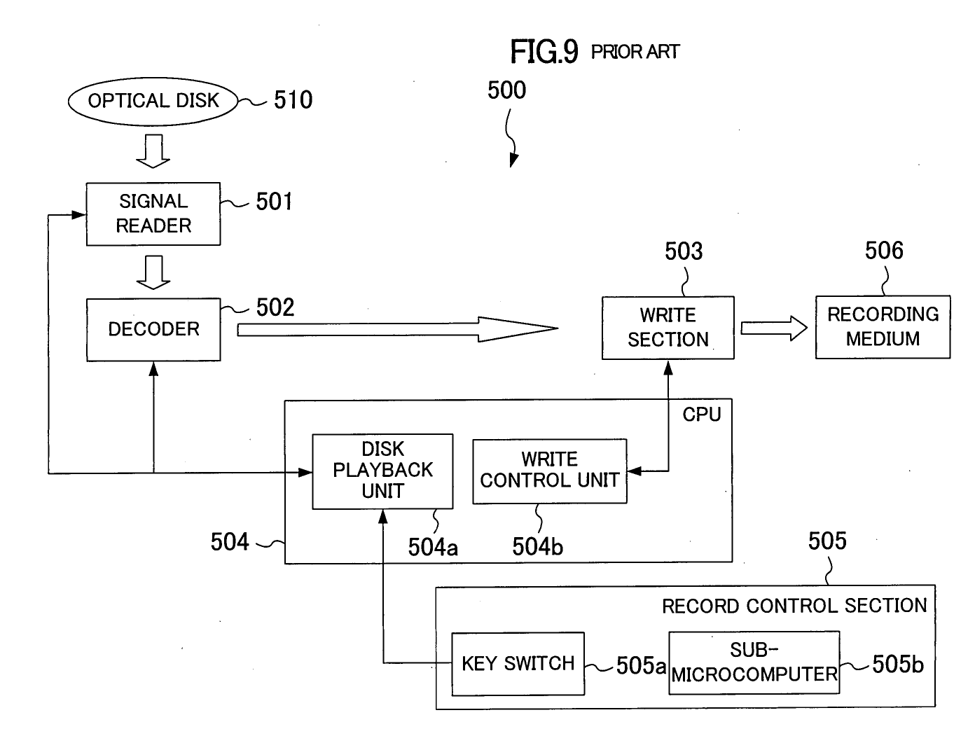

FIG. 10 is a flowchart showing operation of the conventional information recording apparatus.

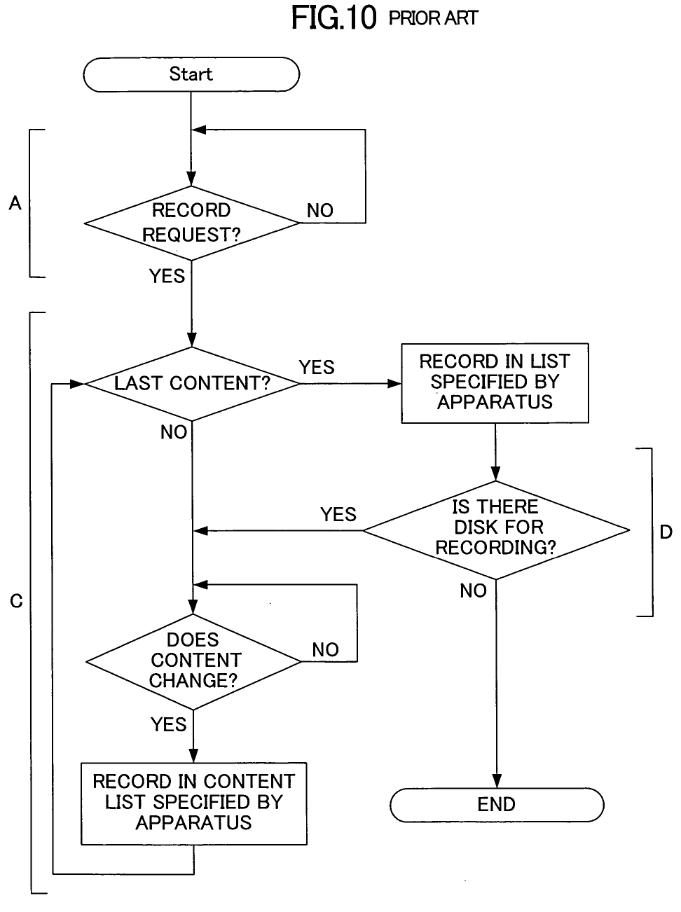

FIG. 11 is a block diagram illustrating a configuration of an information recording apparatus according to a fifth embodiment of the present invention.

FIG. 12 is a flowchart showing operation of the information recording apparatus of the fifth embodiment.

### DETAILED DESCRIPTION OF THE INVENTION

In an information recording apparatus according to the present invention, content selection information (i.e., information presented to select a content to be played back in, for example, playing back contents recorded on a recording medium) is created and a content list including a plurality of such content selection information is recorded on the recording medium. This content list is provided for each category of contents classified according to a given criteria. Content selection information on each content to be recorded on the recording medium is added to a content list according to the category to which the content belongs.

Hereinafter, as embodiments of the present invention, apparatus for reading contents from a plurality of optical disks on which contents including images and sounds are recorded and for recording the contents on another recording medium and also recording a content list as described above on this recording medium will be described with reference to the drawings.

### Embodiment 1

An information recording apparatus 100 according to a first embodiment of the present invention is an example of an apparatus for classifying a content to be recorded by the apparatus, according to which optical disk the content was read from.

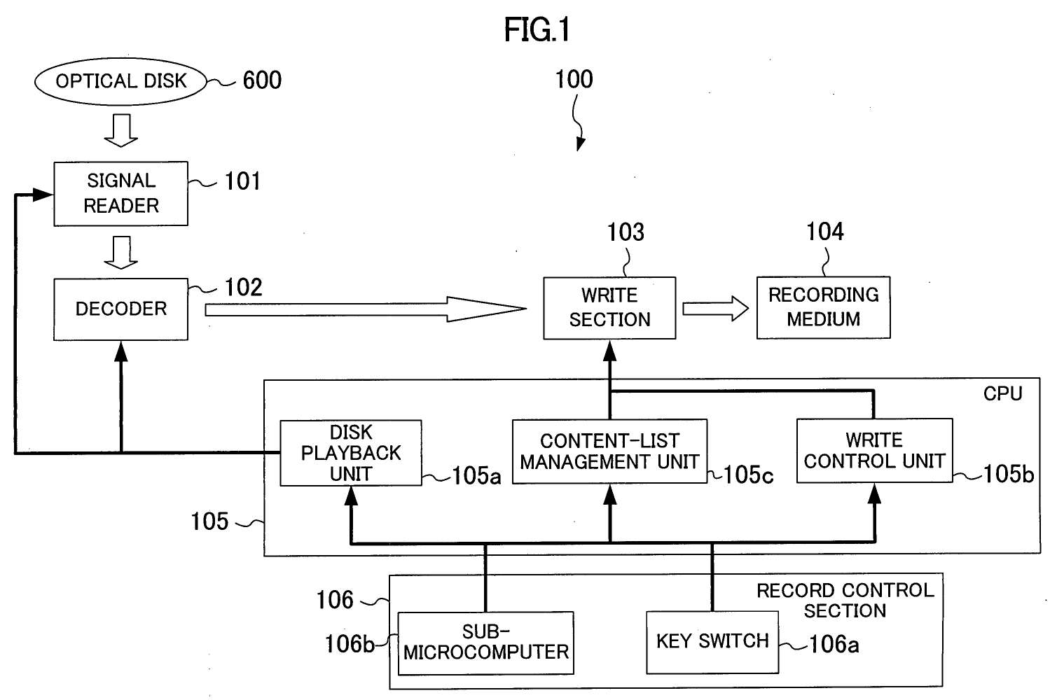

FIG. 1 is a block diagram illustrating a configuration of the information recording apparatus 100.

As illustrated in FIG. 1, the information recording apparatus 100 includes: a signal reader 101; a decoder 102; a write section 103; a recording medium 104; a CPU 105; and a record control section 106.

The signal reader 101 reads contents from an optical disk 600.

The decoder 102 decodes the contents read by the signal reader 101.

The recording medium 104 is a recording medium for recording contents including images and sounds and is a memory card or a MiniDisk, for example.

The write section 103 records information such as the contents on the recording medium 104.

The CPU 105 is a main microcomputer (CPU) responsible for control of the whole apparatus and includes: a disk playback unit 105a; a write control unit 105b; and a content-list management unit 105c.

The disk playback unit 105a of the CPU 105 controls reading and decoding of contents performed by the signal reader 101 and the decoder 102, respectively.

The write control unit 105b controls recording on the recording medium 104 performed by the write section 103.

The content-list management unit 105c classifies a content according to which optical disk 600 the content was input from, adds content selection information on the content to a content list provided for each category of contents, and records the content list on the recording medium 104.

The content selection information is information such as the name of a content (e.g., the title of audio data) and the artist name. In addition to this content selection information, the content list includes information such as the address at which the content is recorded on the recording medium 104. For use in determination whether or not a content list associated with the same category has already been recorded on the recording medium 104, each content list is provided with an ID number of, for example, an optical disk 600 as its name.

The record control section 106 includes: a key switch 106a; and a sub-microcomputer 106b.

The key switch 106a receives a command to start copying, for example, from a user.

The sub-microcomputer 106b outputs, to the CPU 105, information according to the command received by the key switch 106a.

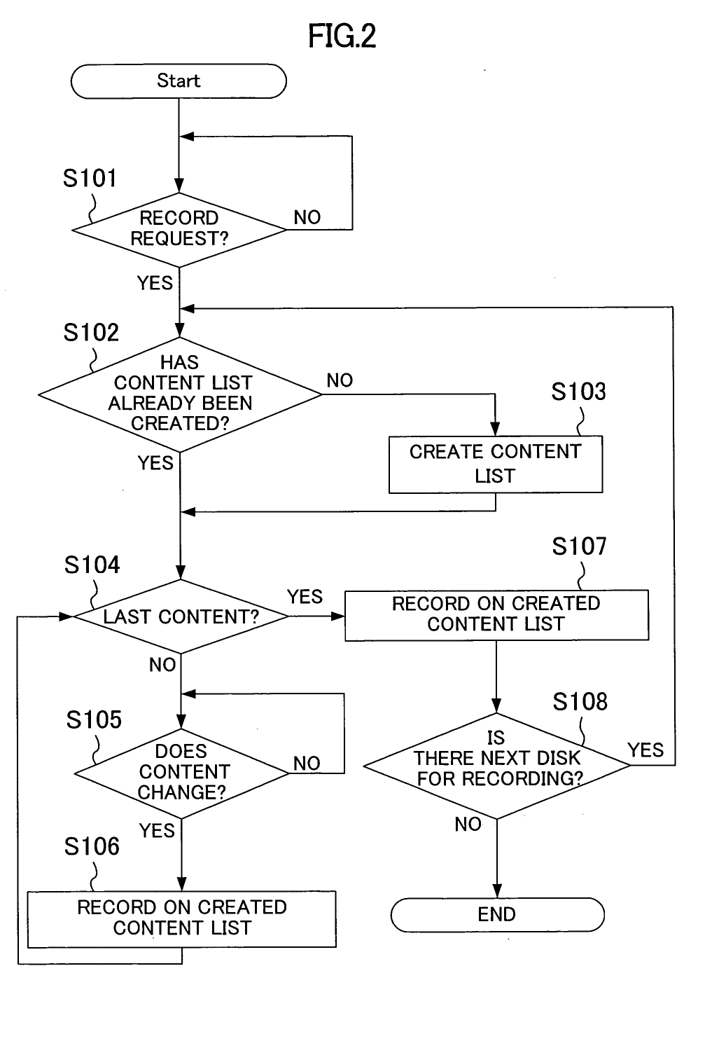

FIG. 2 is a flowchart showing operation of the information recording apparatus 100 having the above configuration. Steps of the operation are as follows:

[S101]

The record control section 106 monitors operation of a user to detect that the user operates the key switch 106a to select (i.e., specify for recording) a content to be recorded on the recording medium 104 from a plurality of contents recorded on an optical disk 600 and enters a command to start recording. When the recording specification and the command to start recording described above are entered, the record control section 106 issues a recording instruction to the CPU 105 and the process proceeds to step S102.

[S102]

It is determined whether or not a content list associated with an optical disk 600 from which data is being read has already been recorded on the recording medium 104. This determination is performed by comparing the ID number of the optical disk 600 from which data is being read and the name of each content list recorded on the recording medium 104.

If the content list associated with the optical disk 600 has already been recorded on the recording medium 104, the process proceeds to step S104 for, for example, recording of a content. If the content list has not been recorded yet, the process proceeds to step S103 for recording of a content list on the recording medium 104.

[S103]

The content-list management unit 105c controls the write section 103 through the write control unit 105b so that a content list is created and recorded on the recording medium 104.

[S104]

In the case of reading the last content from the optical disk 600 which is being played back, the process proceeds to step S107. Otherwise, the process proceeds to step S105.

[S105]

After recording of a content on the recording medium 104, the process proceeds to step S106.

The recording of a content on the recording medium 104 is performed in the following manner:

The record control section 106 outputs an instruction to play back an optical disk 600 to the disk playback unit 105a. Then, the disk playback unit 105a controls the signal reader 101 so that a content is read out from the optical disk 600 and the decoder 102 decodes the read-out content and outputs the decoded content to the write section 103. The write section 103 records the decoded content on the recording medium 104.

[S106] and [S107]

Content selection information as described above is recorded in the content list on the recording medium 104 created at step S103.

[S108]

If there is still an optical disk 600 from which reading of contents has not been completed yet, the process returns to step S102, and recording of content selection information, for example, is continued. Otherwise, the process is terminated.

In this manner, content lists are recorded on the recording medium 104. In playing back contents by a player, for example, if a user specifies a content list, only titles included in this content list are displayed (presented) on a display section, for example, of the player. If the user selects a content to be played back by specifying a displayed title, for example, and commands the player to play back the selected content, a content recorded on the recording medium 104 is played back based on the address included in the content list.

As described above, in this embodiment, content selection information is divided and recorded in a plurality of content lists, so that the amount of information included in one content list is reduced. Accordingly, it is possible to create content lists that reduce the time necessary for finding an intended content and enable easy selection of contents.

In a case in which a specified content is identical to a content which has already been recorded, this specified content is not recorded on the recording medium. Accordingly, the recording medium is effectively used.

Contents are not necessarily read sequentially from a plurality of optical disks 600 for recording as described above. Alternatively, after reading from a first optical disk 600 has been completed, reading from subsequent optical disks 600 may be performed according to operation of a user.

Content selection information, for example, may be recorded in the content lists at each recording of a content on the recording medium 104 as described above or may be recorded by one operation before the start of, or after the completion of, recording of contents.

Contents, such as video data and audio data, recorded on the recording medium 104 are not necessarily obtained by playing back optical disks 600 as in this embodiment, and may be obtained from networks, broadcasts or other recording media. In a case in which contents are obtained from networks or broadcasts, these contents are classified according to the date and time when the contents were distributed and the frequencies of the broadcast stations.

### Embodiment 2

An information recording apparatus 200 according to a second embodiment of the present invention is an example of an apparatus for classifying contents according to tag information containing information such as disk names previously assigned to optical disks 600 and the contents, the names of the contents, artists, and genres.

In the following embodiments and the first embodiment, each component having substantially the same function is denoted by the same reference numeral and description thereof will not be repeated.

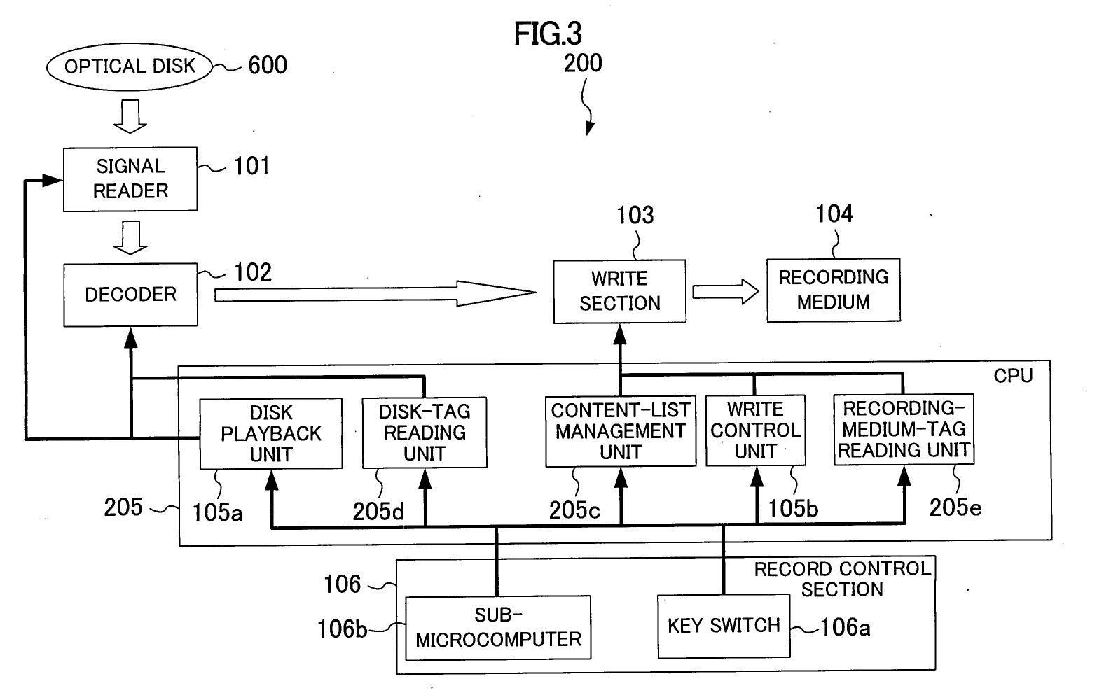

FIG. 3 is a block diagram illustrating a configuration of the information recording apparatus 200 of the second embodiment.

As illustrated in FIG. 3, the information recording apparatus 200 includes a CPU 205 instead of the CPU 105 in the first embodiment.

The CPU 205 includes a content-list management unit 205c instead of the content-list management unit 105c of the CPU 105 in the first embodiment, and additionally includes: a disk-tag reading unit 205d; and a recording-medium-tag reading unit 205e.

The content-list management unit 205c classifies contents according to the tag information, adds content selection information on the contents to content lists associated with the respective categories of the contents, and records the content lists on a recording medium 104. Specifically, content selection information on contents of the same artist, for example, is included in the same content list.

Each of the content lists is provided with tag information such as the names of the contents, for example, as its name. If a user specifies this name for a playback by, for example, a player, content selection information on a specific content list is presented.

The disk-tag reading unit 205d reads the tag information added to optical disks 600 or to contents recorded on the optical disks 600.

The recording-medium-tag reading unit 205e reads tag information added to contents recorded on the recording medium 104.

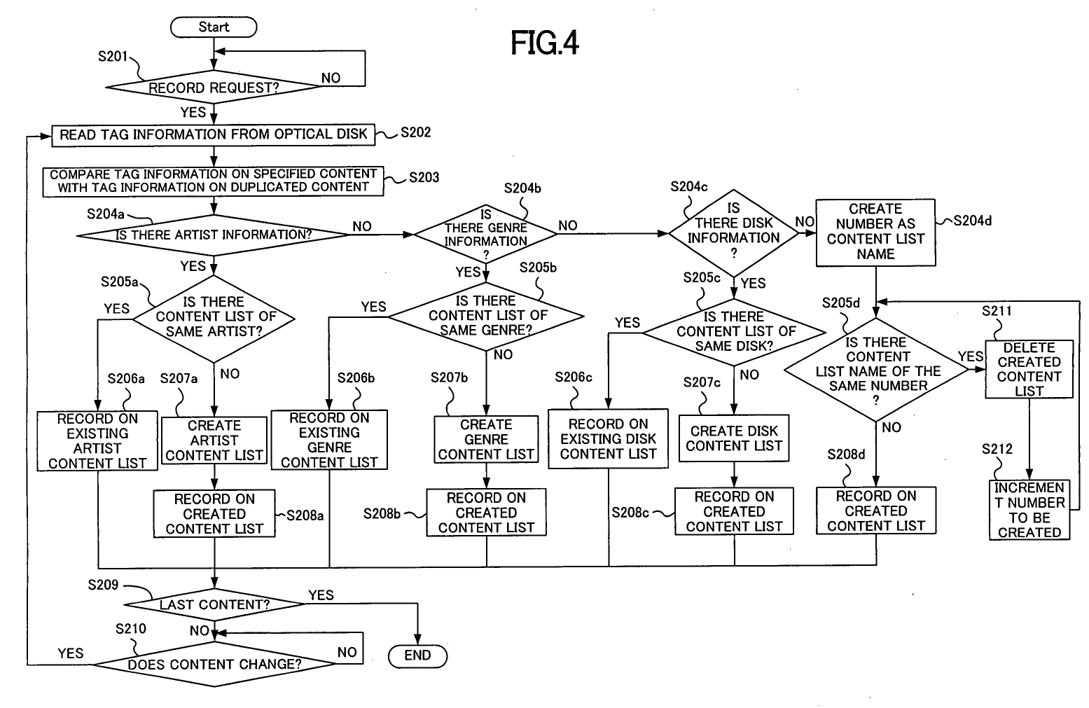

FIG. 4 is a flowchart showing operation of the information recording apparatus 200 having the foregoing configuration. Steps of the operation are as follows:

[S201]

A record control section 106 monitors operation of a user to detect that the user operates a key switch 106a to select (i.e., specify for recording) a content to be recorded on the recording medium 104 from a plurality of contents recorded on an optical disk 600 and enters a command to start recording.

When the recording specification and the command to start recording as described above are entered, the record control section 106 issues a recording instruction to the CPU 205, and the process proceeds to step S202.

[S202]

The recording-medium-tag reading unit 205e reads tag information added to contents which have already been recorded on the recording medium 104.

The disk-tag reading unit 205d reads tag information added to optical disks 600 and to contents read from the optical disks 600.

[S203]

The tag information on a content read from an optical disk 600 is compared with tag information of contents already recorded on the recording medium 104.

[S204a]

It is determined whether or not the contents can be classified according to the artist.

Specifically, if an artist name is included in the tag information added to the content, for example, read from the optical disk 600, the process proceeds to step S205a. Otherwise, the process proceeds to step S204b.

[S205a]

At this step, it is determined whether or not a content list associated with the artist name included in the tag information needs to be created.

Based on the result of the comparison at step S203, if there is a matching of the artist name, it is indicated that a content list associated with this artist exists, and the process proceeds to step S206a. Otherwise, it is indicated that the content list does not exist, and the process proceeds to step S207a.

[S206a]

Content selection information as described above is added to the content list recorded on the recording medium 104.

[S207a]

A content list associated with the artist of the content read by the disk-tag reading unit 205d is created and recorded on the recording medium 104.

[S208a]

Content selection information as described above is recorded in the content list created at step S207a.

[S209]

If the recorded content is the last content, the process is terminated. Otherwise, the process proceeds to step S210.

[S210]

After recording of a content on the recording medium 104, the process proceeds to step S202, and content selection information, for example, on the next content is recorded.

If no artist name is included in the tag information at step S204a, it is determined whether or not a genre name (genre information) is included in the tag information at step S204b. If a genre name is included, the step S205b and the subsequent steps are performed so that a content list associated with the genre is recorded on the recording medium 104 (steps S205b through S208b).

If no genre name is included in the tag information, the process proceeds to step S204c. At step S204c, it is determined whether or not a disk name (disk information) is included in the tag information. If a disk name is included, step S205c and subsequent steps are performed, so that a content list associated with the disk name is recorded on the recording medium 104 (steps S205c through S208c).

If an optical disk 600 and contents recorded on the optical disk 600 include no tag information, content selection information is added to a content list specified by the information recording apparatus 200. Specifically, the content-list management unit 205c adds the content selection information to a content list having a given number, for example, as its name (see steps S204d, S205d, S208d, S211 and S212 in FIG. 4).

With the content lists, in playing back a content by a player, if a user specifies the name (to which an artist name, for example, is added) of a content list, only the titles of contents regarding this artist are displayed on a display section, for example, of the player. Accordingly, it is possible to easily select a content in playback or editing of recorded contents.

Recording of content selection information, for example, in a content list is not necessarily performed for all the specified contents as described above. Alternatively, recording of content selection information, for example, may be performed only for contents having the same tag information as that specified by a user out of input contents.

In addition, tag information for use in classifying contents may be specified by a user, or contents may be classified according to a combination of a plurality of tag information.

With respect to the name of a content list, tag information such as an artist name itself may be added by the information recording apparatus of this embodiment as described above. Alternatively, the name may be input by a user.

### Embodiment 3

An information recording apparatus 300 according to a third embodiment of the present invention is an example of an apparatus for classifying contents according to estimated genre. More specifically, with the information recording apparatus 300, if a content to be recorded cannot be classified based on, for example the genre because of the absence of tag information in the content, frequency characteristics, for example, of the content is analyzed and the genre (genre information) of the content is estimated from the analysis result so that the content is classified based on, for example, the estimated genre.

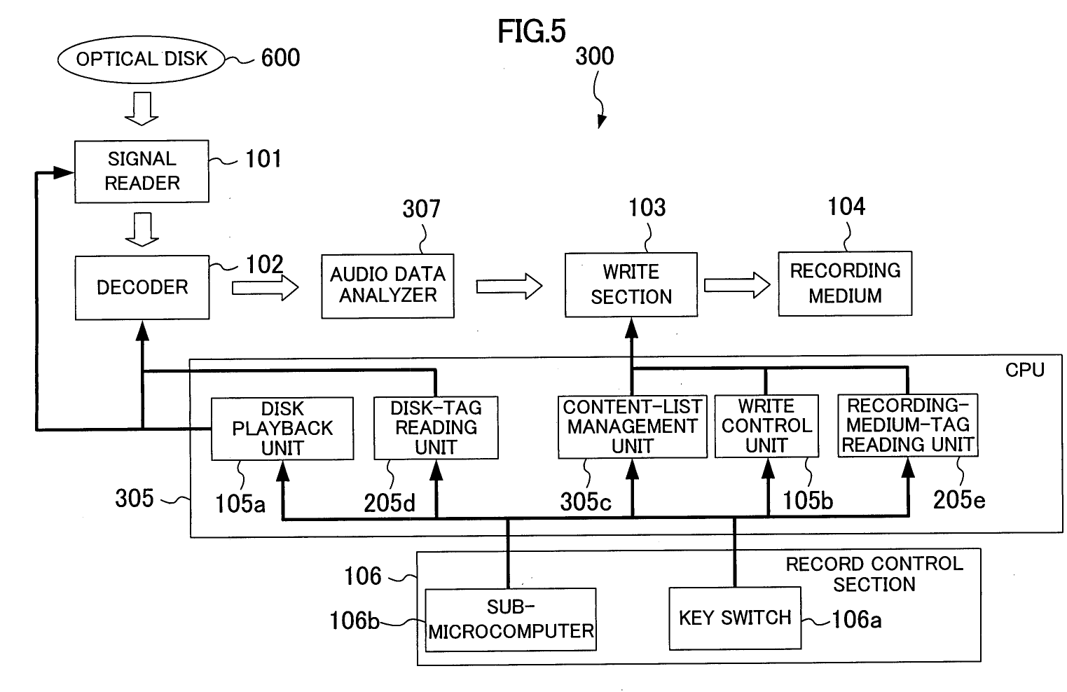

FIG. 5 is a block diagram illustrating a configuration of the information recording apparatus 300 of the third embodiment.

As illustrated in FIG. 5, the information recording apparatus 300 includes a CPU 305 instead of the CPU 205 in the second embodiment, and further includes an audio data analyzer 307.

The CPU 305 includes a content-list management unit 305c instead of the content-list management unit 205c in the second embodiment.

The content-list management unit 305c has the same function as that of the content-list management unit 205c and, if a content list associated with tag information such as the genre cannot be created, creates a content list based on a genre of a content to be recorded estimated by the audio data analyzer 307.

The audio data analyzer 307 analyzes frequency characteristics, for example, of audio data decoded by a decoder 102 and estimates the genre, for example, of the content from the analysis result. A technique for estimating the genre, for example, is already known in techniques such as “Mood Analyzer™ (Music Sommelier™). In such techniques, the tune and the tempo are analyzed by analyzing frequency characteristics, for example, of audio data so that the genre is estimated.

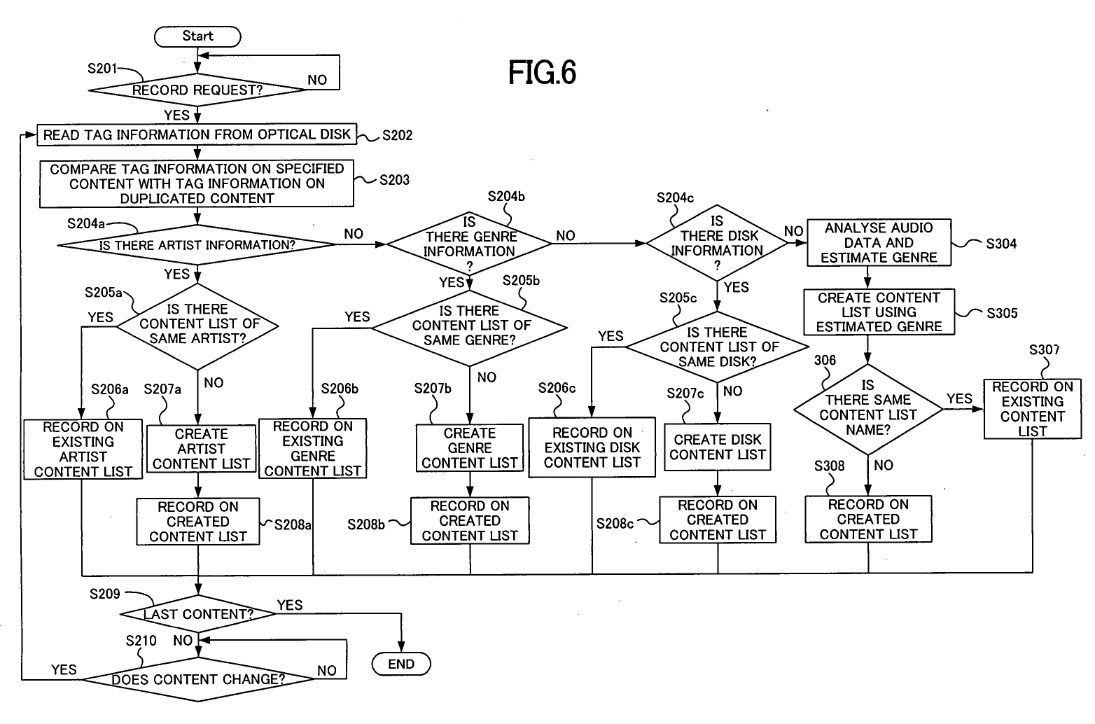

FIG. 6 is a flowchart showing operation of the information recording apparatus 300 having the foregoing configuration. Hereinafter, steps S304 through S308, which are different from those of the apparatus of the second embodiment, will be described. Step S304 is performed when contents on an optical disk 600 do not have tag information such as artist names.

[S304]

The audio data analyzer 307 analyzes audio data decoded by the decoder 102 and estimates the genre.

[S305]

A content list associated with the genre estimated at step S304 is created.

[S306]

If a content list identical to the content list created at step S305 has already been recorded on a recording medium 104, the content list created at step S305 is discarded, and the process proceeds to step S307. Otherwise, the process proceeds to step S308.

[S307]

Content selection information as described above is recorded in the content list on the recording medium 104.

[S308]

The content selection information is recorded in the content list created at step S305.

In this manner, a content list is created based on the genre estimated from audio data. Content selection information on audio data whose estimated genre is the same is added to the same content list.

As described above, in this embodiment, audio data is analyzed to estimate the genre, so that contents having no tag information are categorized according to the genre and a content list associated with the genre is created. This enables easy selection of contents for playback or editing of the contents.

The creation of a content list according to the genre using the audio data analyzer 307 may be performed irrespective of the presence of tag information or may be performed according to a command from a user.

### Embodiment 4

An information recording apparatus 400 according to a fourth embodiment of the present invention is an example of an apparatus for recording a content list to which attribute information for determining whether additional information is allowed to be written in the content list or for identifying a user is added.

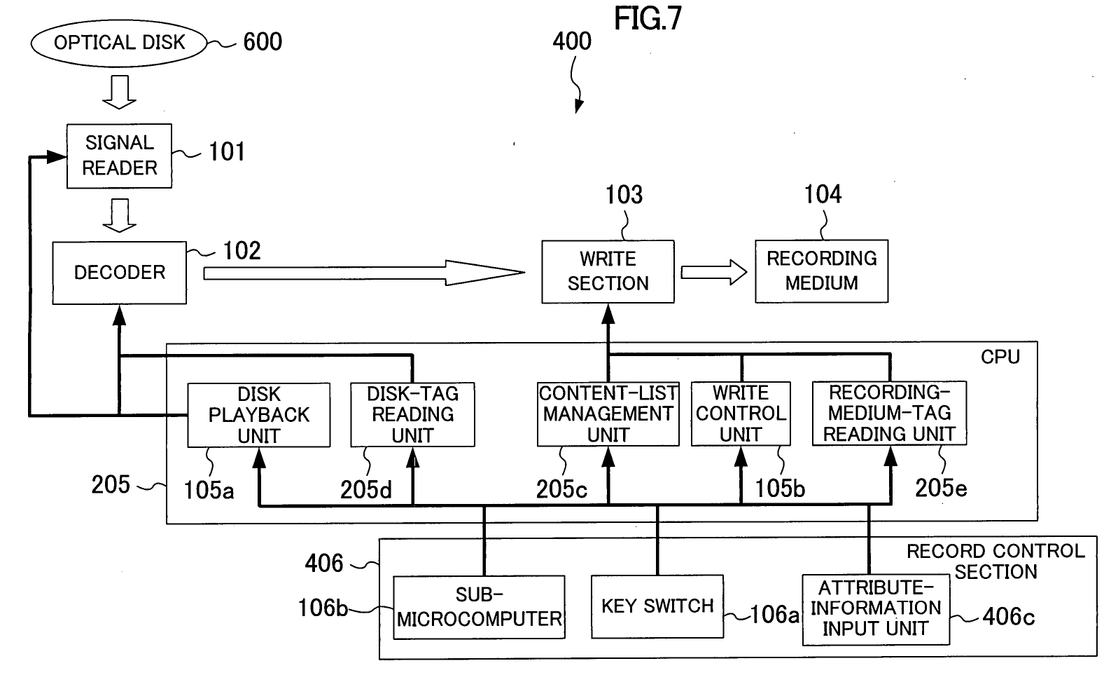

FIG. 7 is a block diagram illustrating a configuration of the information recording apparatus 400 of the fourth embodiment.

As illustrated in FIG. 7, the information recording apparatus 400 includes a record control section 406 instead of the record control section 106 in the second embodiment.

The record control section 406 further includes an attribute-information input unit 406c in addition to the configuration of the record control section 106 in, for example, the second embodiment.

When a content-list management unit 205c creates a new content list, the attribute-information input unit 406c records, in each content list, information such as information indicating prohibition of additional writing or attribute information on, for example, the user. This attribute information is input from, for example, a key switch 106a.

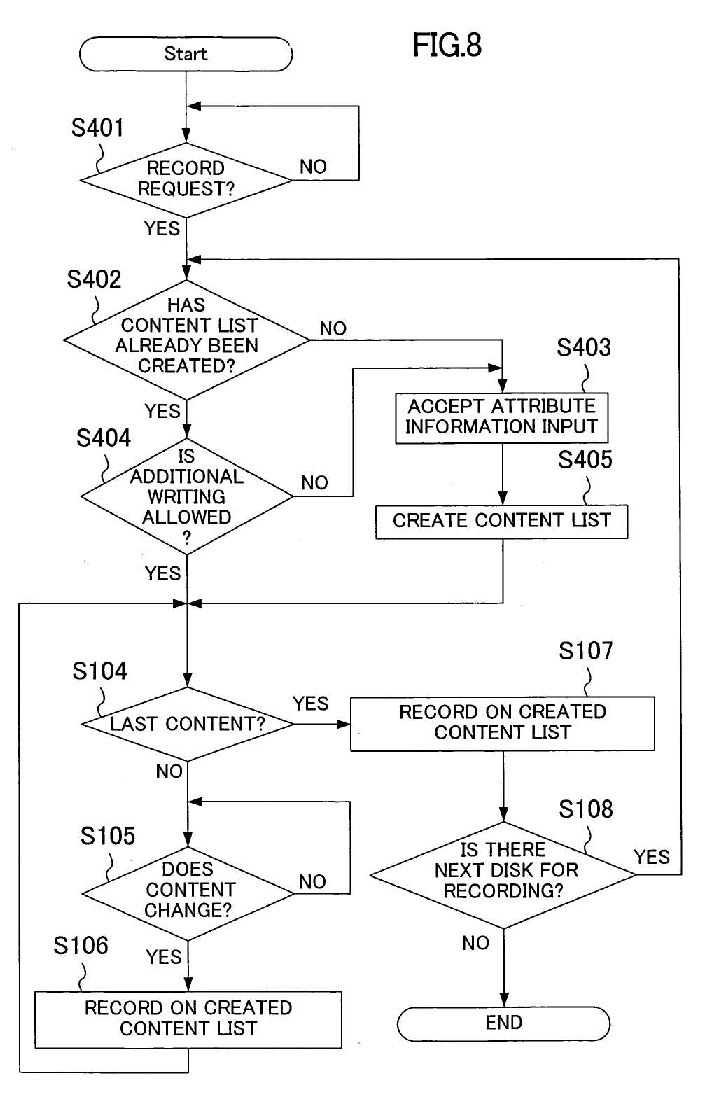

FIG. 8 is a flowchart showing operation of the information recording apparatus 400 having the foregoing configuration.

[S401]

The record control section 406 monitors operation of a user to detect that the user enters a command to start recording. If the command to start recording is entered, the record control section 406 issues an instruction to a CPU 205, and the process proceeds to step S402.

[S402]

The content-list management unit 205c determines whether or not a content list has been already recorded on a recording medium 104.

If a content list has not been recorded yet, the process proceeds to step S403. Otherwise, attribute information in a content list is read, and the process proceeds to step S404.

[S403]

The input of the attribute information from outside the apparatus is accepted (e.g., the user inputs attribute information with the key switch 106a). The attribute-information input unit 406c outputs the input attribute information to the content-list management unit 205c.

[S404]

The content-list management unit 205c determines whether or not additional information is allowed to be written in a content list and whether or not a user whose information is included in attribute information matches the user of this apparatus. For example, the user of this apparatus is identified by, for example, a user ID input by the user with the key switch 106a when the apparatus is powered on, for example.

If additional information is allowed to be written in the content list and there is a matching of the user, step S104 and subsequent steps are performed, additional content selection information is written in the content list and a content is recorded. If additional information is not allowed to be written or there is no matching of the user, the process proceeds to step S403.

[S405]

The content-list management unit 205c creates a content list.

The content list in this case may be created for each optical disk 600 as in the example of the first embodiment or may be created based on tag information such as the artist name as in the example of the second embodiment.

Thereafter, steps S104 through S108 are performed, and the content list is recorded on a recording medium 104 together with a content.

With the content list created by the apparatus of this embodiment, in playing back a content, for example, only contents related to a specific user are presented by utilizing the attribute information. Accordingly, in a situation where a plurality of users share the recording medium 104, contents are easily selected.

The recording media described in the foregoing embodiments are not limited to optical disks, memory cards or MiniDisks and may be any type of media as long as contents are recorded thereon.

The components of the foregoing embodiments may be variously combined as long as these combinations are logically practicable. Specifically, the attribute information may be input in the apparatus of the first through third embodiments, for example.

The tag information described above is an example and is not limited to the above example as long as the tag information allows contents to be categorized.

The apparatus may be configured such that a user inputs character information with, for example, a key switch and tag information or a content list for contents is changed according to the character information input by the user. This configuration enables the name of a content list to be changed so as to be easily selected for playback of contents or displayed information such as the title to be changed.

### Embodiment 5

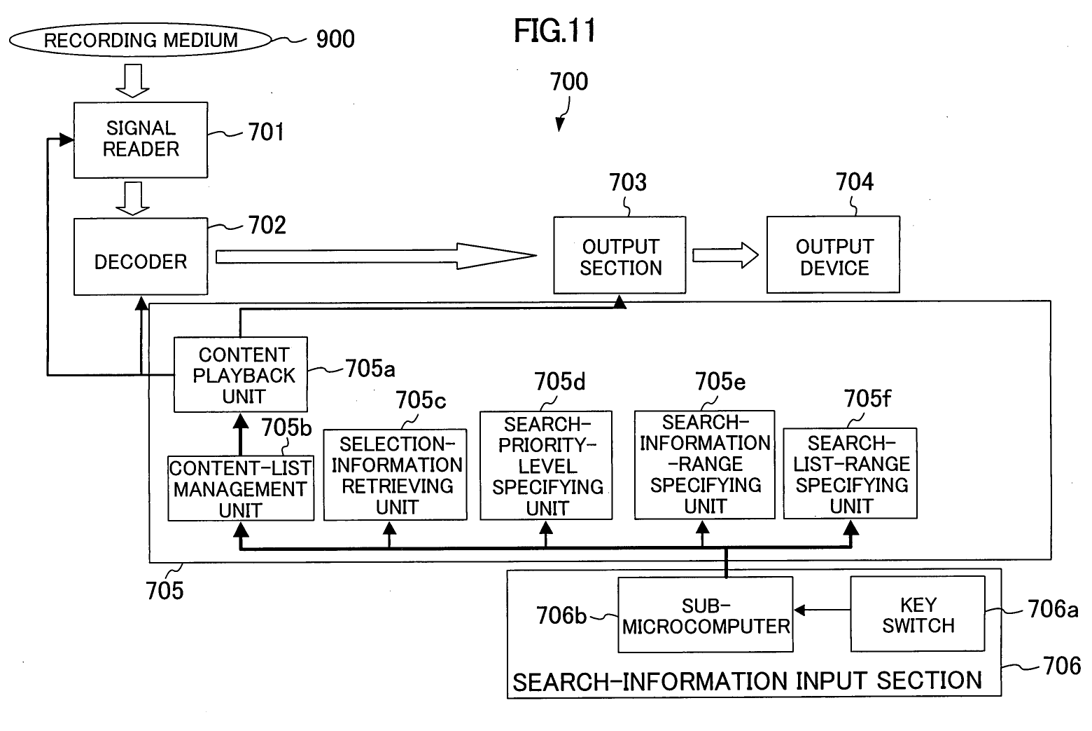

FIG. 11 is a block diagram illustrating a configuration of an information playback apparatus 700 according to a fifth embodiment of the present invention. The information playback apparatus 700 is an example of an apparatus for playing back contents based on a content list as described above recorded by the information recording apparatus of the first embodiment, for example.

In FIG. 11, a recording medium 900 is a MiniDisk, for example, and used for recording contents including images and sounds. On the recording medium 900, a content list as described above is recorded together with contents by the information recording apparatus of the first embodiment, for example.

(Configuration of Information Playback Apparatus 700)

As illustrated in FIG. 11, the information playback apparatus 700 includes: a signal reader 701; a decoder 702; an output section 703; an output device 704; a CPU 705; and a search-information input section 706.

The signal reader 701 reads contents recorded on a recording medium 900.

The decoder 702 decodes the contents read by the signal reader 701.

The output section 703 transmits the contents decoded by the decoder 702 to the output device 704.

The output device 704 is a television set or a speaker, for example, and used for outputting the decoded contents.

The CPU 705 is a main microcomputer (CPU) responsible for control of the whole apparatus. Specifically, the CPU 705 includes: a content playback unit 705a; a content-list management unit 705b; a selection-information retrieving unit 705c; a search-priority-level specifying unit 705d; a search-information-range specifying unit 705e; and a search-list-range specifying unit 705f.

The content playback unit 705a controls the signal reader 701, the decoder 702 and the output section 703 so that contents recorded on the recording medium 900 are output to the output device 704.

The content-list management unit 705b reads and stores a plurality of content lists recorded on the recording medium 900 and collectively manages content selection information in the content lists. The content-list management unit 705b allows a content to be played back using the content playback unit 705a based on one of the content lists and also allows a content to be played back using the content playback unit 705a based on the content selection information selected by the selection-information retrieving unit 705c.

Based on search information (e.g., a search keyword) input by a user through the search-information input section 706, the selection-information retrieving unit 705c searches the content lists stored in the content-list management unit 705b to select content selection information which matches or is similar to the search information. This search is performed by comparing a search keyword with content selection information, character by character, and selecting information which completely matches or has a large number of matching characters (i.e., is similar to) the keyword.

The selection-information retrieving unit 705c narrows the search based on information (also referred to as search information) indicating priority levels specified by the search-priority-level specifying unit 705d, which will be described later, and the search range specified by the search-information-range specifying unit 705e and the search-list-range specifying unit 705f. When a plurality of search information items are provided, the selection-information retrieving unit 705c performs a search based on these search information items.

The search-priority-level specifying unit 705d specifies the priority levels in a search performed through the content lists in the content-list management unit 705b, with respect to the selection-information retrieving unit 705c.

The search-information-range specifying unit 705e specifies a content list to be retrieved out of the content lists in the content-list management unit 705b, with respect to the selection-information retrieving unit 705c.

The search-list-range specifying unit 705f specifies a range of information in the content list to be retrieved, with respect to the selection-information retrieving unit 705c.

The search-information input section 706 includes: a key switch 706a; and a sub-microcomputer 706b.

The key switch 706a receives an input of the search information. For example, a user inputs the priority levels of content lists in such a manner that the user sees a series of content lists managed in the content-list management unit 705b with an OSD (on screen display) such as a display screen, and inputs the priority levels in ascending order from one by using the key switch 706a.

A content list to be retrieved is input by a user in such a manner that the user sees a series of content lists managed in the content-list management unit 705b, for example, with an OSD such as a display screen and selects a content list to be retrieved with the key switch 706a.

An information range in which a search is made is input by a user in such a manner that the user sees a series of content selection information items in content lists managed in the content-list management unit 705b, for example, with an OSD such as a display screen and selects a content selection information item to be retrieved, by using the key switch 706a.

The sub-microcomputer 706b transmits information input from the key switch 706a to the CPU 705.

(Operation of Information Playback Apparatus 700)

In the information playback apparatus 700, when a user inputs a search keyword for retrieving an intended content list for playback with the key switch 706a, the sub-microcomputer 706b sends the input search keyword to the selection-information retrieving unit 705c. At the same time, the sub-microcomputer 706b instructs the content-list management unit 705b to obtain information on the content list.

The content-list management unit 705b instructs the content playback unit 705a to obtain information on all the content lists on the recording medium 900. The content playback unit 705a controls the signal reader 701 and the decoder 702 so that the information on the content lists recorded on the recording medium 900 is sent to the content-list management unit 705b.

The user is allowed to specify priority levels in a search through the content lists managed in the content-list management unit 705b by using the key switch 706a. If the user specifies priority levels, the search-priority-level specifying unit 705d adds information on the specified priority levels as search information for the selection-information retrieving unit 705c.

The user is also allowed to specify a content list to be retrieved by using the key switch 706a, out of the content lists managed in the content-list management unit 705b. If the user specifies a content list to be retrieved, the search-information-range specifying unit 705e adds information specifying the content list as search information for the selection-information retrieving unit 705c.

With respect to content selection information in the content lists managed in the content-list management unit 705b, the user is also allowed to specify content selection information to be retrieved by using the key switch 706a. If the user specifies a search range of content selection information, the search-list-range specifying unit 705f adds information indicating the range as search information for the selection-information retrieving unit 705c.

The selection-information retrieving unit 705c searches content lists by comparing a search keyword input by the user with content selection information in the content-list management unit 705b and selects matching or similar content selection information. In this case, the search is narrowed based on the priority levels and the search range supplied from the search-priority-level specifying unit 705d, the search-information-range specifying unit 705e and the search-list-range specifying unit 705f.

The content-list management unit 705b plays back contents using the content playback unit 705a based on the content selection information selected by the selection-information retrieving unit 705c. The selection-information retrieving unit 705c repeatedly operates after every playback of a content in a content list, so that that a plurality of content lists on the recording medium 900 are successively retrieved, thus enabling automatic successive playbacks.

As described above, in this embodiment, a search is narrowed based on search information specified by a user, thus enabling easy selection of contents specified by the user.

If neither matching information nor similar information is retrieved as a result of a search by the selection-information retrieving unit 705c, a content may be played back by using another content selection information included in a content list associated with a content which is being played back at present or a content which was played back in the past, for example.

### Embodiment 6

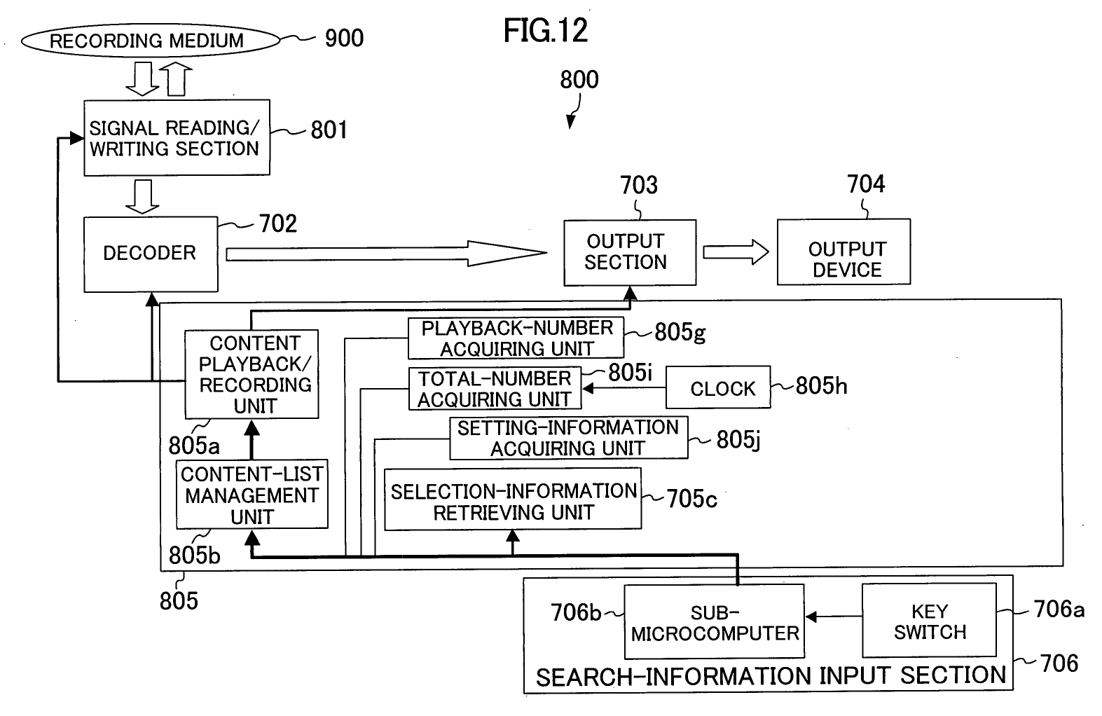

FIG. 12 is a block diagram illustrating a configuration of an information playback apparatus 800 according to a sixth embodiment of the present invention. In this embodiment, as attribute values of a content list, each content list includes: the number of instances in which the content list was used for playback (hereinafter, referred to the content-list use number); the cumulative value (hereinafter, simply referred to as a total number) of instances in which the content list was used at each playback time (on a one-hour basis); and information (hereinafter, referred to as sound-setting information) indicating audio settings such as information indicating whether a surround effect is provided or not and information indicating a sound output effect, e.g., switching information between a main-voice and a sub-voice.

(Configuration of Information Playback Apparatus 800)

As illustrated in FIG. 12, the information playback apparatus 800 includes a signal reading/writing section 801 and a CPU 805, instead of the signal reader 701 and the CPU 705, respectively, of the information playback apparatus 700.

The signal reading/writing section 801 has the function of recording, on a recording medium 900, content lists stored in a content-list management unit 805b, in addition to the function of the signal reader 701. The recording of content lists on the recording medium 900 is controlled by a content playback/recording unit 805a which will be described later.

The CPU 805 includes: the content playback/recording unit 805a; the content-list management unit 805b; a selection-information retrieving unit 705c; a playback-number acquiring unit 805g; a clock 805h; a total-number acquiring unit 805i; and a setting-information acquiring unit 805j.

The content playback/recording unit 805a controls the signal reading/writing section 801, a decoder 702 and an output section 703 so that contents recorded on the recording medium 900 are output to an output device 704. The content playback/recording unit 805a controls the signal reading/writing section 801 so that content lists stored in the content-list management unit 805b as described later are recorded on the recording medium 900.

The content-list management unit 805b reads and stores a plurality of content lists recorded on the recording medium 900 so as to collectively manage content selection information in the content lists. The content-list management unit 805b allows a content to be played back using the content playback/recording unit 805a based on one of the content lists, and also allows a content selected according to a playback mode (described later) specified by a user to be played back using the content playback/recording unit 805a.

In this embodiment, a user specifies three types of playback modes: a mode in which contents are played back using content lists in descending order of frequency in previous use; a mode in which contents are played back by selecting a content list according to the playback time; and a mode in which contents are played back using a selected content list with the same audio settings as those used in the past. One of the modes is specified for playback by a user with a key switch 706a.

The playback-number acquiring unit 805g acquires the content-list use number included in content lists managed in the content-list management unit 805b and transmits the number to the content-list management unit 805b. In a playback using a content list, the playback-number acquiring unit 805g updates the attribute value so as to increment the content-list use number with respect to a content list used for the playback out of the content lists in the content-list management unit 805b, and records the content list whose attribute value has been updated on the recording medium 900 using the signal reading/writing section 801.

The clock 805h outputs the current time to the total-number acquiring unit 805i.

The total-number acquiring unit 805i acquires the total number from the attribute values of content lists managed in the content-list management unit 805b and transmits the acquired total number to the content-list management unit 805b. In a playback using a content list, the total-number acquiring unit 805i updates the attribute value so as to increment the total number with respect to a content list used for the playback out of the content lists in the content-list management unit 805b, and records the content list whose attribute value has been updated on the recording medium 900 using the signal reading/writing section 801.

The setting-information acquiring unit 805j acquires audio-setting information from the attribute value of a content list out of the content lists managed in the content-list management unit 805b and transmits the acquired audio-setting information to the content-list management unit 805b. If a user changes an audio setting during a playback of a content, audio-setting information included in the attribute value of the content list managed in the content-list management unit 805b is updated to current audio-setting information, and the content list whose attribute value has been updated is recorded on the recording medium 900 using the signal reading/writing section 801.

(Operation of Information Playback Apparatus 800)

In the information playback apparatus 800, when a user enters a command to start a playback with the key switch 706a, the content playback/recording unit 805a controls the signal reading/writing section 801 and the decoder 702 so that information on content lists on the recording medium 900 is transmitted to the content-list management unit 805b.

If a user selects the mode in which contents are played back using content lists in descending order of frequency in previous use, the playback-number acquiring unit 805g acquires the content-list use number from all the content lists in the content-list management unit 805b and transmits the content-list use number to the content-list management unit 805b. The content-list management unit 805b starts playback using content lists in descending order of frequency in previous use. In this manner, contents are played back using content lists in descending order of frequency in previous use.

In this case, the playback-number acquiring unit 805g increments the content-list use number in the attribute value of a content list used for the playback and records the content list on the recording medium 900 using the signal reading/writing section 801. Accordingly, the number of instances in which the content list was used for playbacks is reflected in the attribute value of the content list, thus enabling latest information to be used for the next playback.

If a user selects the mode in which contents are played back by selecting a content list according to the playback time, the total-number acquiring unit 805i acquires current-time information from the clock 805h and transmits the current-time information to the content-list management unit 805b. At the same time, the total-number acquiring unit 805i acquires the total number from all the content lists in the content-list management unit 805b and transmits the total number to the content-list management unit 805b. The content-list management unit 805b plays back contents according to the current time. Specifically, the content-list management unit 805b selects content lists in descending order of total number from content lists used for playbacks performed at the same time as the current time, and uses the selected content lists for playback.

In this case, the total-number acquiring unit 805i increments the total number in the attribute value of a content list associated with the current time out of content lists used for playback, and records the content list on the recording medium 900 using the signal reading/writing section 801. This allows latest information to be used for the next playback.

If a user selects the mode in which contents are played back using a selected content list with the same audio settings as those used in the past, the setting-information acquiring unit 805j transmits audio-setting information included in a content list for use in a playback to the content playback/recording unit 805a through the content-list management unit 805b. The content playback/recording unit 805a performs an audio setting according to the transmitted audio-setting information. This allows contents associated with the content list to be always played back with the same audio settings.

In this case, if a user changes an audio setting during a playback of a content, audio-setting information included in a content list associated with the content is updated to current audio-setting information, and the content list is recorded on the recording medium 900 using the signal reading/writing section 801. This allows the current audio-setting information to be reflected in the attribute value of the content list so that latest audio-setting information is used for the next playback.

As described above, in this embodiment, it is possible to automatically play back most appropriate contents by determining a situation where a user used contents in the past. Specifically, contents are played back in the descending or ascending order of frequency, are played back according to the current time, such as morning or the pre-sleep time, or are played back with the same audio settings as those made in the past.

Even in a playback-only apparatus in which a means for recording content lists on a recording medium is not incorporated, it is possible to play back contents in the same manner as long as the attribute values of the content lists are updated by another information recording apparatus.

If another storage device is incorporated in the apparatus of this embodiment so that content lists are held therein, audio-setting information, for example, used for a playback by the apparatus can be used for the next playback even in a case in which data cannot be stored on a recording medium (recording medium 900) on which contents are recorded or in the case of a playback-only apparatus.

If another storage device such as a memory card is incorporated in the information recording apparatus of the first through fourth embodiments to record content lists, this configuration is effective for playback of a recording medium used by these information playback apparatuses by the information playback apparatus of the fifth or sixth embodiment, even in a case in which a recording media on which contents are recorded cannot be rewritten.

Alternatively, one of the information recording apparatuses of the first through fourth embodiments and one of the information playback apparatuses of the fifth and sixth embodiments may be combined to form an information recording/playback apparatus capable of both recording and playback of information.

As described above, in the information recording apparatuses and method, information playback apparatus and method and information recording/playback apparatus according to the present invention, a plurality of content lists are provided so that the amount of information included in each of the content lists is reduced. Accordingly, it is possible to easily select a content in playback or editing after the content has been recorded on a recording medium. As a result, the present invention is useful for, for example, information recording apparatus for recording contents including input sounds and images on a recording medium such as a memory card or a MiniDisk and information playback apparatus for playing back contents thus recorded on the recording medium.

What is claimed is:

1. An information recording apparatus for recording contents on a recording medium, the apparatus comprising:
content recording means for recording contents on the recording medium; and
content-list recording means for adding content selection information items to content lists associated with respective categories of the contents and recording the content lists on the recording medium, the content selection information items being presented for selection in playing back the contents.

2. The apparatus of claim 1, further comprising content reading means for reading a content recorded on a source recording medium,
wherein the content-list recording means adds a content selection information item of the content to a content list associated with the source recording medium from which the content was read, and records the content list on the recording medium.

3. The apparatus of claim 1, wherein the content-list recording means adds the content selection information items to the content lists associated with the respective categories of the contents according to tag information items added to input contents and serving as character information indicating attributes of the contents, and records the content lists on the recording medium.

4. The apparatus of claim 3, wherein the content-list recording means adds the content selection information items to the content lists associated with the respective categories of the contents according to one of, or a combination of some of, the tag information items, and records the content lists on the recording medium.

5. The apparatus of claim 3, wherein the content recording means records, on the recording medium, one or more of input contents which belong to one of the categories associated with a specified one of the content lists.

6. The apparatus of claim 1, wherein in a case in which a content list associated with one of the categories to which a content to be recorded on the recording medium belongs has already been recorded on the recording medium, the content-list recording means adds a content selection information item of the content to be recorded on the recording medium to the already-recorded content list, and in the other case, the content-list recording means adds the content selection information item to a new content list and records the new content list on the recording medium.

7. The apparatus of claim 1, further comprising genre estimating means for analyzing each of input contents and estimating a genre of the content,
wherein the content-list recording means adds the content selection information items to the content lists according to the estimated genre, and records the content lists on the recording medium.

8. The apparatus of claim 1, wherein each of the content lists is provided with identification information associated with a user, and
in recording the contents on the recording medium, the content-list recording means adds the content selection information items to an associated one of the content lists in a case in which identification information input from outside the apparatus matches the identification information provided to the content list, and the content-list recording means adds the content selection information items to a new content list in the other case.

9. The apparatus of claim 1, further comprising:
character information inputting means for inputting character information from outside the apparatus; and
information changing means for changing the content selection information items included in the content lists as character information, tag information items of input contents and tag information items of contents recorded on the recording medium into character information input from the character information inputting means.

10. A method for recording contents on a recording medium, the method comprising:
a content recording step of recording a content on the recording medium; and
a content-list recording step of adding a content selection information item of the content to a content list associated with a category to which the content belongs, and recording the content list on the recording medium, the content selection information item being presented for selection in playing back the content.

11. An information playback apparatus for playing back a plurality of contents recorded on a recording medium, the apparatus comprising:
selection-information retrieving means for retrieving a content selection information item which matches or is similar to one or more content selection information items specified by a user from content selection information items included in a plurality of content lists associated with respective categories of the contents, each of the content lists including content selection information items presented for selection of one or more contents belonging to an associated one of the categories; and
content playback means for playing back a content associated with the content selection information item retrieved by the selection-information retrieving means,
wherein according to a specification by a user, the selection-information retrieving means selects one of the content lists through which a search is made and sets a search range with respect to content selection information items in the selected content list.

12. The apparatus of claim 11, wherein after a search through one of the content lists, the selection-information retrieving means makes a search through another selected content list, and these searches are successively performed.

13. The apparatus of claim 11, further comprising search-priority-level specifying means for specifying priority levels of the content lists through which a search is to be made, with respect to the selection-information retrieving means.

14. The apparatus of claim 11, further comprising:
information-search-range specifying means for specifying one of the content lists through which a search is to be made, with respect to the selection-information retrieving means; and
search-list-range specifying means for specifying a search range for the content selection information items in the content list through which a search is to be made, with respect to the selection-information retrieving means.

15. An information playback method for playing back a plurality of contents recorded on a recording medium, the method comprising:
a selection-information retrieving step of retrieving a content selection information item which matches or is similar to one or more content selection information items specified by a user from content selection information items included in a plurality of content lists associated with respective categories of the contents, each of the content lists including content selection information items presented for selection of one or more contents belonging to an associated one of the categories; and
a content playback step of playing back a content associated with the retrieved content selection information item in a case in which a matching or similar content selection information item is retrieved at the selection-information retrieving step, while performing a playback using another content selection information item included in the content lists associated with one of the contents which is being played back at present or was played back in the past in a case in which neither a matching nor similar information item is retrieved at the selection-information retrieving step.

16. The apparatus of claim 11, further comprising playback-number acquiring means for acquiring number information indicating the number of instances in which each of the content lists was used for playback,
wherein the selection-information retrieving means retrieves a content selection information item from one of the content lists selected according to the number information acquired by the playback-number acquiring means.

17. The apparatus of claim 11, further comprising total-number acquiring means for acquiring information indicating a total number of instances in which each of the content lists was used for playback at a given time,
wherein the selection-information retrieving means retrieves a content selection information item from one of the content lists selected according to the information indicating the total number acquired by the total-number acquiring means.

18. The apparatus of claim 11, further comprising setting-information acquiring means for acquiring audio-setting information indicating an audio setting in a sound output effect in a playback of one of the contents,
wherein the content playback means plays back the content with an audio output setting according to the audio-setting information acquired by the setting-information acquiring means.

19. An information recording/playback apparatus for recording contents on a recording medium and playing back contents from the recording medium, the apparatus comprising:
content recording means for recording contents on the recording medium;
content-list recording means for adding content selection information items to content lists associated with respective categories of the contents, and recording the content lists on the recording medium, the content selection information items being presented for selection in playing back the contents;
selection-information retrieving means for retrieving one of the content selection information items which matches or is similar to one or more content selection information items specified by a user:
content playback means for playing back one of the contents associated with the content selection information item retrieved by the selection-information retrieving means; and
playback-number acquiring means for acquiring number information indicating the number of instances in which each of the content lists was used,
wherein the selection-information retrieving means retrieves the content selection information item from one of the content lists selected according to the number information acquired by the playback-number acquiring means.

20. An information recording/playback apparatus for recording contents on a recording medium and playing back contents from the recording medium, the apparatus comprising:
content recording means for recording contents on the recording medium;
content-list recording means for adding content selection information items to content lists associated with respective categories of the contents, and recording the content lists on the recording medium, the content selection information items being presented for selection in playing back the contents;
selection-information retrieving means for retrieving one of the content selection information items which matches or is similar to one or more content selection information items specified by a user:
content playback means for playing back one of the contents associated with the content selection information item retrieved by the selection-information retrieving means; and
total-number acquiring means for acquiring information indicating a total number of instances in which each of the content lists was used for playback at a given time,
wherein the selection-information retrieving means retrieves the content selection information item from one of the content lists selected according to the information indicating the total number acquired by the total-number acquiring means.

21. An information recording/playback apparatus for recording contents on a recording medium and playing back contents from the recording medium, the apparatus comprising:
content recording means for recording contents on the recording medium;
content-list recording means for adding content selection information items to content lists associated with respective categories of the contents, and recording the content lists on the recording medium, the content selection information being presented for selection in playing back the contents;
selection-information retrieving means for retrieving one of the content selection information items which matches or is similar to one or more content selection information items specified by a user:
content playback means for playing back one of the contents associated with the content selection information item retrieved by the selection-information retrieving means; and
setting-information acquiring means for acquiring audio-setting information indicating an audio setting in a sound output effect in a playback of one of the contents,
wherein the content playback means plays back one of the contents with an audio output setting according to the audio-setting information acquired by the setting-information acquiring means.

22. The apparatus of claim 1, further comprising content-selection-information storing means for storing the content selection information items.

23. The apparatus of claim 11, further comprising content-selection-information storing means for storing the content selection information items.

24. The apparatus of claim 19, further comprising content-selection-information storing means for storing the content selection information items.

25. The apparatus of claim 20 further comprising content-selection-information storing means for storing the content selection information items.

26. The apparatus of claim 21, further comprising content-selection-information storing means for storing the content selection information items.
